(19) United States
(12) Patent Application Publication
(10) Pub. No.: US 2019/0017787 A1
(43) Pub. Date: Jan. 17, 2019

(54) MULTI-LAYER ARMOR

(71) Applicants: Michael Arlen, Palmyra, VA (US); Charles William Kemp, Bumpass, VA (US)

(72) Inventors: Michael Arlen, Palmyra, VA (US); Charles William Kemp, Bumpass, VA (US)

(73) Assignee: Kno Corrosion Technologies LLC, Fredericksburg, VA (US)

(21) Appl. No.: 16/008,785

(22) Filed: Jun. 14, 2018

Related U.S. Application Data
(60) Provisional application No. 62/520,767, filed on Jun. 16, 2017.

(51) Int. Cl. F41H 5/04

(52) U.S. Cl. CPC F41H 5/0478; F41H 5/0421; B32B 7/02; F41H 5/0442; F41H 5/0428

(57) ABSTRACT

In one general aspect, an armor panel includes a first layer, a second layer, and a third layer. The first layer having a first thickness (T1). The second layer is coupled to the first layer and has a second thickness (T2). The second layer includes one of the following materials steel, cermet, cemented carbide, a metal matrix composite, or a combination thereof. The third layer is coupled to the second layer and has a third thickness (T3). The third layer includes an ultra-high molecular weight polyethylene (UHMWPE) composite or syntactic foam.

### CROSS-REFERENCE TO RELATED APPLICATION

This application claims the benefit of U.S. Provisional Application No. 62/520,767, filed Jun. 16, 2017, and titled “Multi-Layer Armor,” which is incorporated by reference in its entirety.

### SUMMARY

In a first general aspect, the subject matter described in this specification can be embodied in armor panel that includes a first layer, a second layer, and a third layer. The first layer having a first thickness (T₁). The second layer is coupled to the first layer and has a second thickness (T₂). The second layer includes one of the following materials steel, cermet, cemented carbide, a metal matrix composite, or a combination thereof. The third layer is coupled to the second layer and has a third thickness (T₃). The third layer includes an ultra-high molecular weight polyethylene (UHMWPE) composite or syntactic foam. And, a ratio of the second thickness to the third thickness (T₂/T₃) is between 0.42 and 1.0.

This and other implementations can each optionally include one or more of the following features. In some implementations, the material of the third layer includes a material selected from one or more of the following: random chopped fibers, aligned chopped fibers, unidirectional fibers, bidirectional fibers, cross-ply fibers, two-dimensional woven fibers, and three-dimensional woven fibers. In some implementations, the material of the third layer is bonded together by a thermoplastic or thermoset polymer.

In a second general aspect, the subject matter described in this specification can be embodied in an armor panel that includes a first layer, a second layer, and a third layer. The first layer has a first thickness (T₁). The second layer is coupled to the first layer. The second layer has a second thickness (T₂). The third layer is coupled to the second layer and has a third thickness (T₃). The third layer has a flexural modulus that is less than a flexural modulus of the second layer. And, a ratio of the second thickness to the third thickness (T₂/T₃) is between 0.42 and 1.0.

In a third general aspect, the subject matter described in this specification can be embodied in an armor panel that includes a first layer, a second layer, and a third layer. The first layer has a first thickness (T₁). The second layer is coupled to the first layer. The second layer has a second thickness (T₂). The second layer is configured to, when impacted by a projectile, blunt, deform, erode, or fracture the projectile. The third layer is coupled to the second layer and has a third thickness (T₃). The third layer is configured to exhibit, when impacted by the projectile, one or more of shear plugging or fiber breaking. And, a ratio of the second thickness to the third thickness (T₂/T₃) is between 0.42 and 1.0.

In a fourth general aspect, the subject matter described in this specification can be embodied in an armor panel that includes a first layer, a second layer, and a third layer. The first layer has a first thickness (T₁). The second layer is coupled to the first layer. The second layer has a second thickness (T₂). The second layer is configured to, when impacted by a projectile, blunt, deform, erode, or fracture the projectile. The third layer is coupled to the second layer and has a third thickness (T₃). The third layer is configured to exhibit, when impacted by the projectile, one or more of shear plugging or fiber breaking.

These and other implementations can each optionally include one or more of the following features.

In some implementations, the panel is configured to be oriented with the first layer facing in a direction of potential projectiles when the panel is in use.

In some implementations, the first layer is configured to protect the other layers from environmental conditions.

In some implementations, the first layer includes a metal, a fiberglass reinforced polymer composite, or a carbon fiber reinforced polymer composite.

In some implementations, a ratio of the first thickness to the third thickness (T₁/T₃) is between 0.0028 and 0.1.

In some implementations, the second layer is configured to blunt, deform, erode, or fracture the projectile, when impacted by the projectile.

In some implementations, the second layer includes a material selected from one or more of the following: steel, cermet, cemented carbide, and metal matrix composite.

In some implementations, the third layer includes a fiber reinforced composite material.

In some implementations, the material of the third layer includes a material selected from one or more of the following: random chopped fibers, aligned chopped fibers, unidirectional fibers, bidirectional fibers, cross-ply fibers, two-dimensional woven fibers, and three-dimensional woven fibers. In some implementations, the material of the third layer is bonded together by a thermoplastic or thermoset polymer.

In some implementations, the third layer has a flexural modulus between 600-800 ksi as determined by ASTM D790.

In some implementations, the third layer has a flexural modulus between 675-725 ksi as determined by ASTM D790.

In some implementations, the panel includes a protective wrap covering side surfaces of each of the plurality of layers. In some implementations, the protective wrap comprises a metal, a fiberglass reinforced polymer composite, or a carbon fiber reinforced polymer composite. In some implementations, the protective wrap has a thickness (T_{pw}) and wherein a ratio of the first thickness to the fourth thickness (T₁/T_{pw}) is between 0.5 and 1.0. In some implementations, the protective wrap comprises a same material as that of the first layer.

In some implementations, the panel includes a fourth layer coupled to the third layer. In some implementations, the fourth layer includes a metal, a fiberglass reinforced polymer composite, or a carbon fiber reinforced polymer composite. In some implementations, the fourth layer has a fourth thickness (T₄) and a ratio of the first thickness to the fourth thickness (T₁/T₄) is between 0.5 and 1.0. In some implementations, the fourth layer comprises a same material as that of the first layer.

In some implementations, the panel is coupled to an object. In some implementations, the object is a vehicle. In some implementations, the object is a structure. In some implementations, the object is a piece of furniture.

Some implementations include a foam layer disposed between at least one of the panels and the object. In some implementations, the foam layer includes a polymeric foam or a metallic foam.

In some implementations, the one or more panels are spaced apart from the object so as to form a gap between at least one of the panels and the object.

In some implementations, at least one of the panels are installed within a wall or a ceiling of a structure.

In a fourth general aspect, the subject matter described in this specification can be embodied in a method for manufacturing an armor panel. The method includes the steps of: cleaning surfaces of a core layer, where the core layer includes a material selected from one or more of the following: steel, cermet, cemented carbide, and metal matrix composite. Preparing a surface of a front face layer by cleaning and abrading the surface. Applying an adhesive between the abraded surface of the front face layer and one of the surfaces of the core layer and placing the core layer in contact with the abraded surface of the front face layer. Preparing a surface of a back face layer, the back face layer comprising an ultra-high molecular weight polyethylene (UHMWPE) composite or a syntactic foam. Applying an adhesive between the prepared surface of the back face layer and the core layer and placing the back face layer in contact with the core layer.

This and other implementations can each optionally include one or more of the following features. In some implementations, the method includes pressing the front face layer, the core layer, and the back face layer together with a pressure of between 0.5 and 50 lb/in². In some implementations, a ratio of a thickness of the core layer to a thickness of the back face layer is between 0.42 and 1.0.

Particular implementations of the subject matter described in this specification can be implemented so as to realize one or more of the following advantages. Implementations may provide a multi-layer armor panel where the layers behave synergistically to absorb high impact energy from projectiles. Implementations may reduce or eliminate sympathetic damage to adjacent armor when one armor panel is impacted by a projectile without the need to isolate individual armor panels. Implementations may provide armor that can be machined by various methods and to precision sizes and shapes. Implementations may provide an armor system where armor panels can be recycled after being impacted. Tiles can be cleaned, refurbished, and reused.

In some implementations, multiple multi-layer armor panels can be coupled together using bracketed channels to form walls or furniture. Implementations of the armor panels can be constructed using cermet tiles to form armor panels of various shapes and sizes to construct armored objects such as walls or furniture (e.g., desks or cubicles). In some implementations, the armor panels can be formed using an array of tiles without the need for isolation layers between tiles to prevent sympathetic damage to adjacent tiles. Thus, implementations may have a reduced weight compared to similar armor panels that use ceramics. For example, in some implementations a cermet core layer is formed by using an adhesive (e.g., cyanate ester) to adhere an array of cermet tiles together along the seams. This process adds minimal weight to the armor panels. Implementations may provide more efficient processes to form multi-layered armor panels by eliminating the necessity of isolating adjacent ceramic tiles from each other.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1A depicts a side cutaway view of an exemplary armor panel of an armor system according to implementations of the present disclosure.

FIG. 1B depicts a top view of a second layer of the armor panel of FIG. 1A.

FIG. 2 depicts the armor panel of FIG. 1A with an exemplary protective wrap.

FIG. 3 depicts the armor panel of FIG. 1A with a side covering and a rear cover plate.

FIGS. 4A-4C depict implementations of the armor panel of FIG. 1A installed on an object.

FIG. 5 is a flowchart of an example process for making a multi-layer armor panel.

Like reference symbols in the various drawings indicate like elements.

### DETAILED DESCRIPTION

The present disclosure generally relates to a multi-layer armor panel. The layers of the armor panel behave synergistically to absorb high impact energy from high velocity projectiles including, but not limited to lead bullets, shrapnel, fragments, steel-core projectiles, armor piercing projectiles, and explosively formed projectiles. The layers can be laminated together with an adhesive to form armor panels which can be attached to objects including, but not limited to, vehicles and structures. Vehicles on which the armor panel can be installed include, but are not limited to, cars, trucks, boats, trains, public transportation, military vehicles (e.g., tanks, light armored vehicles), or aircraft. Structures on, or inside which, the armor panel can be installed include, but are not limited to, ceilings, floors, and walls of buildings, vaults, or safes. In some implementations, the armor panels described herein can be incorporated into building materials. For example, armor panels can be incorporated into building materials used to make walls, floors, ceilings, and/or furniture. In some implementations, the armor panel can be combined with other armor panels to form protective panels, systems, and the like.

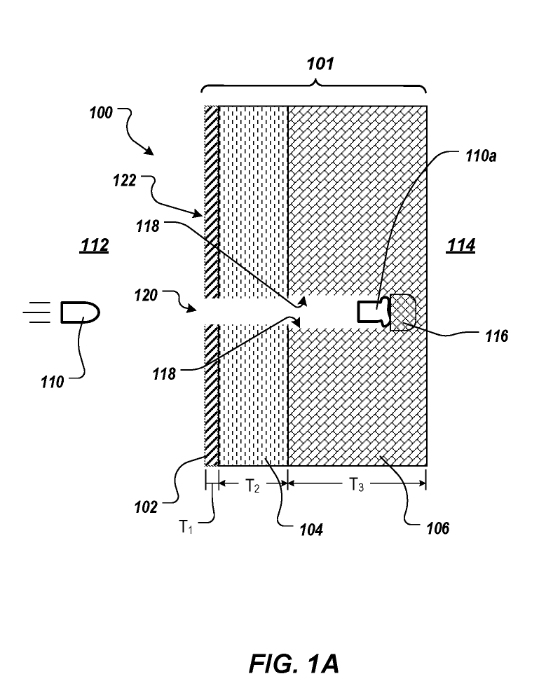

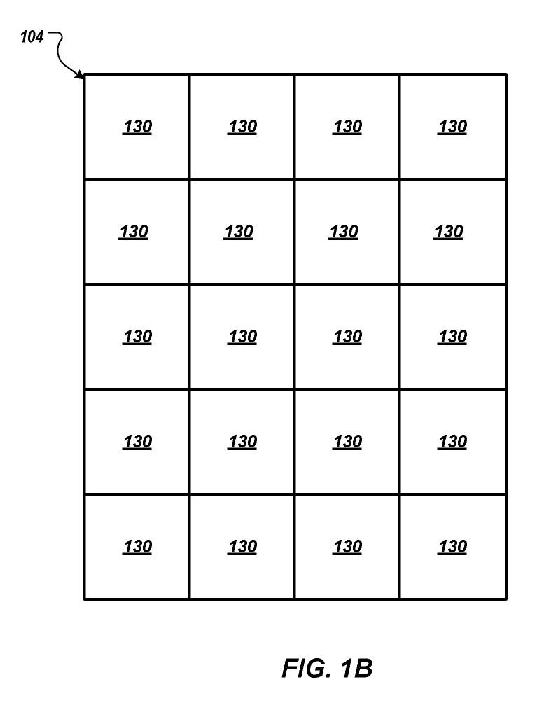

FIG. 1A depicts a side cutaway view of an example multi-layered armor panel 100 according to implementations of the present disclosure. The panel 100 includes a set of layers 101 that are arranged to behave synergistically with respect to one-another as a projectile 110 impacts or passes through the layers 101. The panel 100 includes a first layer 102 that forms the “projectile side” 112 of the panel 100. As used herein, the “projectile side” 112 is the side of the armor panel 100 that is oriented towards the direction from which projectiles are expected to come. This is the side of the armor panel 100 which will receive the initial impact of any projectile 110 that is fired or launched at the armor panel 100. For example, the “projectile side” 112 generally faces away from the object that the armor is being used to protect (e.g., the interior of a vehicle or a structure). The first layer 102 protects the other layers 104, 106 from environmental conditions. The second layer 104 functions to deform, erode, and or fracture the projectile (deformed projectile 110a) as the projectile 110 impacts and passes through the first layer 102. The third layer 106 provides structural support to the first layer 102.

For example, when impacted by a projectile 110, the second layer 104 deforms the projectile 110, resulting in a deformed projectile 110a. The third layer 106 provides structural support to the second layer 104 to reduce damage caused by the projectile 110 to the second layer 104. Third layer 106 provides support to the second layer 104 by being designed to fail by a shear plugging mechanism, fiber breakage, or a combination thereof behind the projectile 110 impact site in the second layer 104. In some implementations, the third layer 106 does not deform or delaminate from the area surrounding the impact site. For example, when a fiber reinforced composite is subjected to high-velocity impact with a projectile 110, the shear stress through the thickness in the composite near the periphery of the projectile 110 rises. If this stress exceeds a shear-plugging strength for the composite, then failure occurs and a shear plug 116 is formed.

For example, plug 116 is sheered from the third layer 106 as the projectile 110a passes through the second layer 104. The failure mechanism of the second layer 104 may ensure that sufficient supporting structure 118 remains behind the hole 120 in first layer 102 to provide adequate stopping power for subsequent projectiles that may impact near the hole 120. The second layer 104 may also begin to distribute the impact energy of the projectile 110 over a greater area of the panel 100. For example, plug 116 may have a larger surface area than the projectile 110a, thereby, distributing the energy of the projectile across a greater area of the third layer 106.

In some implementations, the layers 102-106 of panel 100 are constructed to have particular thickness ratios between the layers. For example, layer 102 has a thickness T₁, layer 104 has a thickness T₂, and layer 106 has a thickness T₃. Tile 100 can have a thickness ratio between layers 102 and 106 (e.g., T₁/T₃) that is between approximately 0.0025 and 0.1. In some implementations, the thickness ratio between layers 102 and 106 (e.g., T₁/T₃) is between approximately 0.0028 and 0.1000. In some implementations, the thickness ratio between layers 102 and 106 (e.g., T₁/T₃) is approximately 0.1. Tile 100 can have a thickness ratio between layers 104 and 106 (e.g., T₂/T₃) that is between approximately 0.4 and 1. In some implementations, the thickness ratio between layers 104 and 106 (e.g., T₂/T₃) is between approximately 0.48 and 1.0. In some implementations, the thickness ratio between layers 104 and 106 (e.g., T₂/T₃) is approximately 0.5.

In some cases, the effectiveness of the armor panel 100 at stopping various projectiles (e.g., different caliber projectiles, different types of projectiles, or different velocity projectiles) depends more on the thickness ratios between the layers 102-106 than on the individual thicknesses of each layer or any particular layer. For example, layers 102-106 can be of varying thickness, but maintain the above thickness ratios in order to meet desired levels of armor protection (e.g. various levels of the STANEG 4569 armor standard and/or National Institute of Justice armor standard). For example, layers 102-106 of an implementation of the armor panel 100 designed to meet the requirements of STANEG 4569 Level 4 may be thinner than layers 102-106 of an implementation designed to meet STANEG 4569 Level 5.

In some implementations, layers 104 and 106 have a decreasing flexural modulus. That is, in some implementations, second layer 104 is made of a material that has a flexural modulus that is greater than that of the third layer 106. For example, the third layer 106 can have a flexural modulus between 600-800 ksi as determined by ASTM D790. In some implementations, third layer 106 can have a flexural modulus between 675-725 ksi as determined by ASTM D790.

Layers 102-106 are each coupled one to the other. Each layer 102-106 can be coupled to the subsequent layer by, for example, an adhesive, a laminate, or a mechanical fastener (e.g., hook and loop fasteners). In some implementations, first layer 102 can be coupled to second layer 104 using, for example, a thermoplastic, thermoset, pressure sensitive adhesive, or a hook and loop fastener. Second layer 104 can be coupled to third layer 106 using, for example, a thermoplastic, thermoset, pressure sensitive adhesive, or a hook and loop fastener.

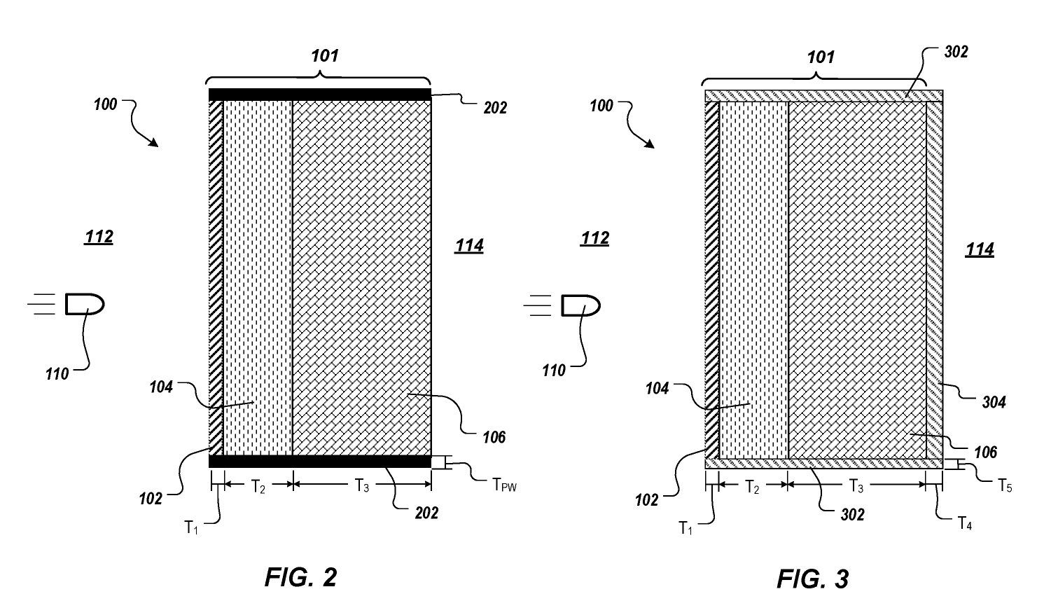

First layer 102 protects the other layers of panel 100 from environmental conditions to which armor panel 100 may be subject during use. For example, referring to FIG. 2, a wrap 202 may protect layers 104 and 106 from weather, abrasive particles, dampness, dust and dirt, etc. First layer 102 can be made from materials that will protect the other layers of panel 100 from external environmental conditions expected in a geographic region in which the panel 100 will be used. For example, first layer 102 can be made of metal, fiberglass reinforced polymer composite, or carbon fiber reinforced polymer composite. For example, fiberglass reinforced polymer composite material may provide better environmental protection for panel 100 in a maritime region. A metal maybe used indoors in controlled environmental conditions or where erosion may take place. For example, a metal layer 102 may be used for armor panels 100 attached to the front or underbelly of a vehicle which may be impacted by damaging particles (e.g., rocks and debris), whereas a firber reinforced polymer composite layer 102 may be used for armor panels 100 attached to the side of a vehicle which may experience less abrasive conditions. In some examples, first layer 102 can have a thickness (T₁) that is approximately 0.02-0.25 inches (0.5-6.35 mm).

In some implementations, the outer surface 122 of the first layer 102 can include a design. For example, a decorative coating or material, such as paint, fabric, or coating can be applied to the outer surface 122 of layer 102.

Second layer 104 (also referred to as the “core layer”) is made of a material with high hardness, high fracture toughness. Second layer 104 can have a high flexural modulus. Second layer 104 can be made as monolith or as a tile array. Second layer 104 can be made of materials including, but not limited to, metal such as a high hard steel, cermet, cemented carbide or a metal matrix composite material. For example, second layer 104 can made of an armor steel including, but not limited to, Armox 500T, Armox 600T, or MIL-DTL-46100. In some examples, second layer 104 can have a thickness (T₂) that is between approximately 0.197-3.0 inches (5-76.3 mm).

Second layer 104 can made of cermet. The cermet can be created by a self-propagating high temperature synthesis (SHS) processes or spark plasma sintering (SPS). The cermet formulation can include a metal binder and ceramic inclusions. The metal binder may be between 10-40 percent-by-weight and the ceramic inclusions may be between 90-60 percent-by-weight of the cermet. In some implementations, the metal binder may be between 15-25 percent-by-weight and the ceramic inclusions may be between 85-75 percent-by-weight of the cermet. Ceramic inclusion grain size of the cermet can be between 1 nm-500 μm. In some implementations, the ceramic inclusion grain size of the cermet can be between 100 nm-20 μm. The cement formulation can include, but is not limited to, any of the following combinations of metal binder and ceramic inclusions: titanium binder with titanium carbide inclusions, iron binder with titanium carbide inclusions, steel alloy binder with titanium carbide inclusions, nickel binder with titanium carbide inclusions, nickel/molybdenum binder with titanium carbide inclusions, nickel alloy with titanium carbide inclusions, aluminum binder with titanium carbide inclusions, or aluminum alloy binder with titanium carbide inclusions. In some implementations, the cermet can include an alloy of one or more of the following metals: aluminum, iron, nickel, or titanium.

Second layer 104 can be made of a metal matrix composite material. The metal matrix composite can be made by sintering, gravity assisted infiltration, pressure assisted infiltration, additive manufacturing, or other similar processes. The metal matrix composite can include between 10-40 percent-by-weight of metal binder and between 90-60 percent-by-weight of ceramic inclusions. In some implementations, the metal matrix composite can include between 15-25 percent-by-weight of metal binder and between 85-75 percent-by-weight of ceramic inclusions. Ceramic inclusion grain size of the metal matrix composite can be between 1 nm-500 μm. In some implementations, the ceramic inclusion grain size of the metal matrix composite can be between 100 nm-20 μm. The metal binder for the metal matrix composite can be titanium, titanium alloy, nickel, nickel alloy, iron, steel, aluminum, aluminum alloy, magnesium, or magnesium alloy. The ceramic inclusions for the metal matrix composite can be titanium carbide, tungsten carbide, silicon carbide, boron carbide or alumina.

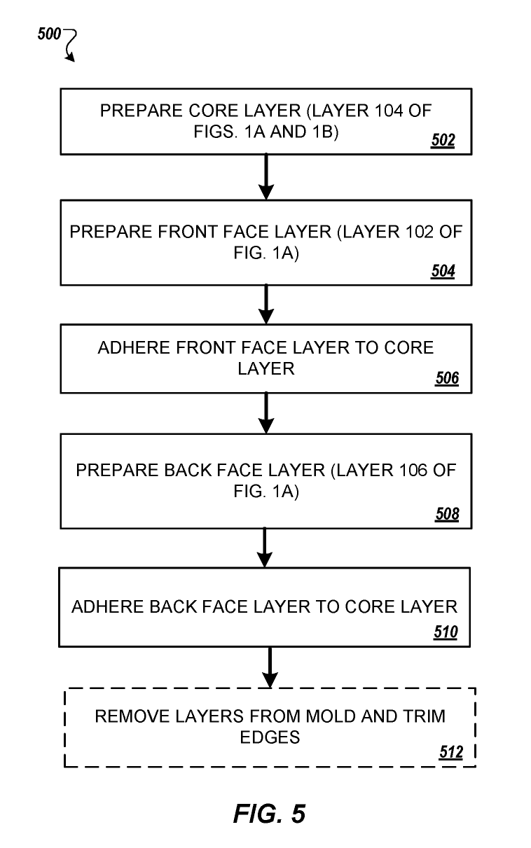

In some implementations, layer 104 is composed of an array of tiles 130 as shown in FIG. 1B. For example, the core layer 104 of the armor panel 100 can be constructed by attaching multiple cermet tiles 130 together to form a panel 100 of a desired shape or size. As described in more detail below in reference to FIG. 5, the tiles 130 can be placed in a mold and adhered together to form the core layer 104 for an armor panel 100. In some implementations, the first layer 102 provides additional bonding strength to core layer 104 to maintain the tiles 130 adhered together and prevent motion between adjacent tiles 130.

The third layer 106 forms the “protected” or backside 114 of the armor panel 100. As used herein, the “protected side” 114 is the side of the armor panel 100 that is oriented towards the object that the armor panel 100 is being used to protect. For example, when in use, the armor panel 100 is oriented such that the third layer 106 is the closest layer to the object that is to be protected.

Third layer 106 can be made of ultra-high molecular weight polyethylene (UHMWPE) composite or syntactic foam. In some implementations, third layer 106 can be made from random chopped fibers, aligned chopped fibers, unidirectional fibers, bidirectional fibers, cross-ply fibers, two-dimensional woven fibers, or three-dimensional woven fibers. Third layer 106 can be reinforcement embedded in a polymer matrix. Fiber reinforcements can include, but are not limited to, auxetic, glass fiber, carbon fiber, boron fiber, balsite fiber, inorganic geo-polymer fiber, or polymeric fiber. The fibers can be bound using a thermoplastic or thermoset polymer. In some examples, third layer 106 can have a thickness (T₃) that is between approximately 0.197-7.0 inches (5-178 mm).

Third layer 106 can be a monolithic layer. In some implementations, third layer 106 can be made up of multiple composite layers of the same material adhered together using a thermoplastic, thermoset, or pressure sensitive adhesive. In some implementations, the surface molecular structure of composite layers of the third layer 106 can be modified to improve adhesion between the composite layers. For example, the surface molecular structure can be modified using a torch, flame, ozonolisis, or corona discharge. Such processes oxidize the composite surface of the third layer 106 to provide reaction sites between the adhesive and the composite from which the third layer 106 is made to increase the energy absorption ability of the armor panel 100 by promoting cohesive failure of the adhesive between the layer 104 and layer 106 which maintains the integrity of the panels 100.

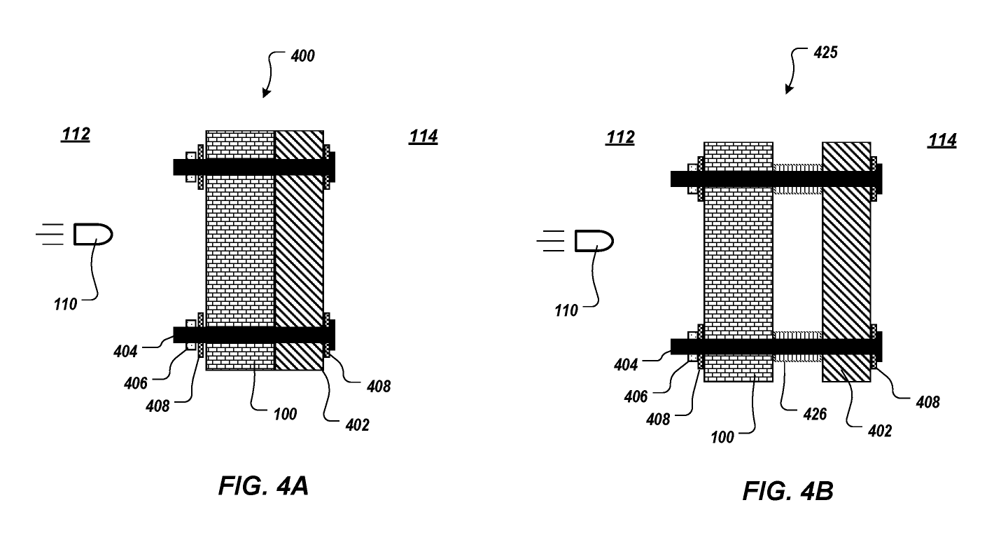

FIGS. 2 and 3 depict implementations of armor panel 100 with various casing configurations. FIG. 2 depicts armor panel 100 with an exemplary wrap 202. Wrap 202 is coupled to side surfaces of the layers 101 of panel 100. For example, wrap 202 can be a perimeter wrap attached around the perimeter of panel 100 (e.g., around side surfaces of the layers 101). For example, wrap 202 can be adhered to side surfaces of the layers 101. Wrap 202 may protect layers 101 from environmental conditions to which armor panel 100 may be subject during use. For example, wrap 202 may protect layers 101 from weather, mechanical abrasion, dampness, dust and dirt, etc.

Wrap 202 can be made of metal, fiberglass reinforced polymer composite, or carbon fiber reinforced polymer composite. In some implementations, wrap 202 is made of the same material as layer 102. Wrap 202 has a thickness T_{PW}. In some examples, wrap 202 can have a thickness (T_{PW}) that is approximately 0.02-0.125 inches (0.5-3.175 mm). In some implementations, the thickness ratio between wrap and layer 102 (e.g., T_{PW}/T₁) is between approximately 0.5 and 1.0.

FIG. 3 depicts the armor panel 100 of FIG. 1A with a side covering 302 and rear cover 304. Side covering 302 is coupled to side surfaces of the layers 101 of panel 100. Rear cover 304 is coupled to the rear surface of layer 106. For example, side covering 302 and rear cover 304 can form a protective shell that encapsulates layers 104 and 106. For example, side covering 302 can be adhered to side surfaces of the layers 101. Rear cover 304 can be adhered to the rear surface of layer 106. Side covering 302 and rear cover 304 may protect layers 104 and 106 from environmental conditions to which armor panel 100 may be subject during use. For example, side covering 302 and rear cover 304 may protect layers 104 and 106 from weather, dampness, dust and dirt, etc.

Side covering 302 can be made of metal, fiberglass reinforced polymer composite, or carbon fiber reinforced polymer composite. In some implementations, side covering 302 is made of the same material as layer 102. Side covering 302 has a thickness T₅. In some examples, side covering 302 can have a thickness (T₅) that is approximately 0.02-0.125 inches (0.5-3.175 mm). In some implementations, the thickness ratio between side covering 302 and layer 102 (e.g., T₅/T₁) is between approximately 0.5 and 1.0.

Rear cover 304 can be made of metal, fiberglass reinforced polymer composite, or carbon fiber reinforced polymer composite. In some implementations, rear cover 304 is made of the same material as layer 102. Rear cover 304 has a thickness (T₄) that is approximately 0.02-0.25 inches (0.5-6.35 mm). In some implementations, the thickness ratio between side covering 302 and layer 102 (e.g., T₁/T₄) is between approximately 0.5 and 1.0.

Individual panels 100 can be assembled to provide protection for areas that are larger than each individual panel 100. For example, panels 100 can be attached to the surface of an object to protect the object from projectiles. That is, a group of panels can be arranged and attached to a surface of a structure such as a building (e.g., a wall, roof, floor, ceiling), a vehicle, or furniture. In some examples, a protective barrier can be created by arranging and attaching the armor panels 100 together without the need to attach panels 100 to a separate object. For example, panels 100 can be assembled together to form a wall or a front surface of a desk.

In some implementations, panels can be assembled in a frame. The frame can hold the panels 100 in metal extrusions or fiber reinforced composite pultrusions in the form of c channel, u-channel, or L-channel joints that are configured to hold armor panels 100.

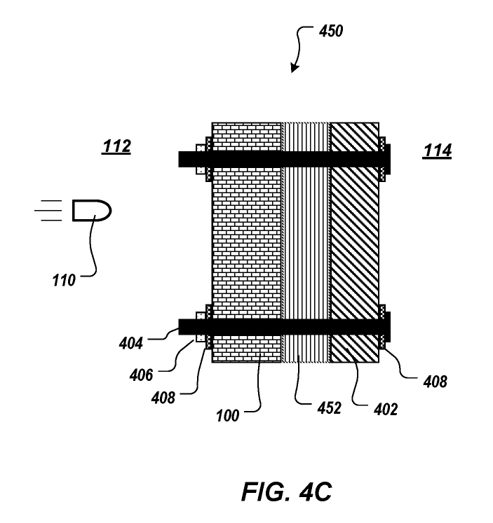

FIGS. 4A-4C depict implementations of the armor panel 100 of FIG. 1A installed on an object 402. For example, FIG. 4A illustrates a panel 100 attached to an object 402 using fasteners (e.g., nuts, bolts, washers). The object 402 can be, for example, a structure (e.g., a building), a vehicle, or furniture. The panel 100 is attached to the object 402 using bolts 404, nuts 406 and washers 408.

FIG. 4B illustrates a panel 100 attached to an object 402 using fasteners and being spaced apart from the object 402. As shown in FIG. 4B, in some implementations, spacers 426 can be used to space armor panels 100 from an object 402 to which the panels 100 are attached. Such configurations provide a gap between the panels 100 and the object 402. In some examples, providing a gap between the panels 100 and object 402 may permit the panels 100 to bend or flex as needed when impacted by a projectile 110. The space between the panel 100 and the object 402 provides additional distance between the object 402 and any projectiles 110 that may impact the armor panel 100.

FIG. 4C illustrates a panel 100 attached to an object 402 including foam 452 disposed between the panel 100 and the object 402. As shown in FIG. 4C, in some implementations, a layer of foam 452 can be disposed between the armor panel 100 and object 402. Such configurations provide additional protection between the panels 100 and the object 402. In some examples, providing foam 452 between the panels 100 and object 402 may permit the panels 100 to bend or flex as needed when impacted by a projectile 110.

The foam 452 can be a polymeric foam or a metallic foam. For example, foam 4452 can be made of a polymeric syntactic foam, open cell metal foam, closed cell metal foam, or a metallic syntactic foam. The foam 452 provides a volume into which the panel 100 can deform while absorbing the energy of the projectile 110. The foam 452 may assist the panel 100 in absorbing the kinetic energy of the projectile 110 as it is crushed when the panel 100 deforms upon impact with the projectile 110. The foam 452 also may provide mechanical integrity to support the panel 100 on a surface of an object 402 while providing space between the object 402 and the armor panel 100.

FIG. 5 is a flowchart of an example process 500 for making a multi-layer armor panel 100. Process 500 can be performed manually or by automated manufacturing equipment. For clarity, the steps of process 500 are recited in a particular sequence, however, various steps may be performed in a different sequence.

In step 502, the core layer of the armor panel is prepared. The core layer refers to layer 104 of FIG. 1A, for example. The core tiles are prepared by cleaning the front and rear surfaces of the core material of any dirt, oils, or foreign materials using appropriate solvents. Example solvents include, but are not limited to, acetone or toluene. However, the particular solvent used for a particular implementation may be dependent on the exact materials used for a given core layer. Core material tiles can then be placed into a mold with interior dimensions representative of the final shape of the armor panel. The mold can be made out of silicon rubber, metal, or plastic that can be sprayed with a mold release agent. In some implementations, the mold can be the perimeter wrap 202 discussed above in reference to FIG. 2 or the side covering 302 discussed above in reference to FIG. 3.

An adhesive (e.g., cyanate ester) is applied to the corners and/or seams of the core layer tiles in a manner that creates bonds between the array of tiles 130 placed in the mold, for example as shown in FIG. 1B. The adhesive provides sufficient integrity for the array of tiles 130 form a rigid core layer structure that can be handled as a monolithic unit when the adhesive is fully cured (e.g., layer 104 of FIGS. 1A and 1B). Once prepared, the entire core layer (e.g., the adhered array of core layer tiles) can be removed from the mold as a unit.

Adhering an array of cermet tiles 130 together along the seams may add minimal weight to the armor panels 100. In addition, the use of cermet tiles 130 may eliminate the need for isolation layers between tiles 130, further reducing the weight of the panel 100 structure.

In step 504, the front face layer (e.g., layer 102 of FIG. 1A) is prepared. The front face layer 102 is prepared by abrading the surface of the front face layer 102 that will be adhered to the core layer 104. The abraded surface of the front face layer 102 is cleaned of any debris, dirt, oils, etc. Example solvents include, but are not limited to, acetone or toluene. However, the particular solvent used for a particular implementation may be dependent on the exact materials used for a given front face layer.

In step 506, the front face layer 102 is adhered to the core layer 104. The front face layer 102 is placed into the mold with the abraded surface facing up. The mold may be placed on a silicon mat with the surface to receive adhesive up and apply adhesive. An adhesive is applied to the abraded surface of the front face layer 102 and the core layer 104 is placed onto the adhesive.

In step 508, the back face layer (e.g., layer 106 of FIG. 1A) is prepared. For example, in implementations of the panel 100 in which layer 106 is made of UHMWPE, the surface that will be adhered to the core layer 104 can be treated by corona discharge or flame to oxidize the surface to provide adhesion. In implementations of the panel 100 in which layer 106 is made of syntactic foam, the surface of the back face layer 106 that will be adhered to the core layer 104 can be cleaned of debris and oils, and primed. For example, a primer material that promotes adhesion between surface of syntactic foam and an interlayer adhesive may be applied to the surface of the back face layer 106.

In step 510, the back face layer 106 is adhered to the core layer 104. Adhesive is applied to the second surface of the core layer 104. The back face layer 106 is placed onto the adhesive. The layers are pressed together to ensure the adhesive contact between each layer during curing. For example, pressure can be applied to the layers (e.g., layers 102-106 of FIG. 1A). For example, the layers can be pressed together with a pressure of between approximately 0.5-50 lb/in² to ensure adhesive contact between all three layers until the adhesive has cured. In some implementations, the layers can be pressed together with a pressure of between approximately 0.5-10 lb/in² to ensure adhesive contact between all three layers until the adhesive has cured.

In some implementations, a rear cover (e.g., rear cover 304 of FIG. 3) is applied to the back surface of the back face layer 106 before the layers are pressed together. For example, a surface of the rear cover 304 surface can be prepared by abrading the surface and cleaning the surface using appropriate solvents. Example solvents include, but are not limited to, acetone or toluene. However, the particular solvent used for a particular implementation may be dependent on the exact materials used for a given rear cover. Adhesive can be applied to the rear surface of the back face layer 106. The rear cover can be placed onto the back face layer 106 with the prepared surface of the rear cover 304 toward the adhesive.

In optional step 512 the sandwiched layers of the panel 100 (e.g., layers 102-106, and, optionally rear cover 304) are removed from the mold. For example, in implementations in which the mold does not serve as the wrap (e.g., wrap 202 of FIG. 2) or side covering (e.g., side covering 302 of FIG. 3), the adhered layers are removed from the mold and any excess adhesive that may have squeezed out of the interlayers during the curing process under pressure is trimmed from the side surfaces of the panel 100.

In some implementations, the armor panel can be fabricated with holes for attachment to a object (e.g., bolt holes). For example, holes can be pre-fabricated in each material layer prior to panel assembly. As another example, holes can be cored using the proper drill bits for each material layer which will require at least two different specialized drill bits for the core layer (e.g., layer 104) and the back face layer (e.g., layer 106). In implementations, that include a rear cover, holes for attachment can be drilled into the rear cover after the encapsulation process.

In some implementations, the core layer (e.g., layer 104) and the back face layer (e.g., layer 106 can be adhered together using steps 502, 508, and 510 of process 500 described above. The adhered layers 104 and 106 can then be wrapped in fabric and vacuum assisted resin transfer molding techniques can be used to encapsulate the layers in an environmentally protective shell. The encapsulating shell can be formed from metal, fiberglass reinforced polymer composite, or carbon fiber reinforced polymer composite. Holes for attachment can be drilled through all the layers after encapsulation using the proper drill bits for each layer.

As used herein, the terms “approximately,” “about,” or “substantially” refer to measurements or dimensions that are within acceptable engineering, machining, or measurement tolerances. For example, a dimension that is stated as being approximately 0.01 in is not intended to require an implementation of the disclosure to have that exact dimension, but is intended to encompasses reasonable variations that are within acceptable engineering, machining, or measurement tolerances for the material being used and/or the process used to machine the material. Similarly, dimensions that are stated without a qualifying term such as “approximately,” “about,” or “substantially” are also not limited to exact measurements, but are intended to encompasses reasonable variations that are within acceptable engineering, machining, or measurement tolerances for the material being used and/or the process used to machine the material.

As used herein the term “flexural modulus” refers to the flexural modulus of a material as determined by a standardized flexural test such as the American Section of the International Association for Testing Materials—ASTM D 790 standard. While the ASTM standard is referred to in this disclosure, similar standards developed by other trade organizations (e.g., American National Standards Institute (ANSI) and International Organization for Standardization (ISO)) may also be used to determine flexural moduli values (e.g., EN ISO 178 (ANSI standard is ASTM)).

While a number of examples have been described for illustration purposes, the foregoing description is not intended to limit the scope of the invention, which is defined by the scope of the appended claims. There are and will be other examples and modifications within the scope of the following claims.

What is claimed is:

1. An armor panel comprising:
a first layer having a first thickness (T₁);
a second layer coupled to the first layer, the second layer having a second thickness (T₂) and comprising a material selected from the group consisting of steel, cermet, cemented carbide, and metal matrix composite; and
a third layer coupled to the second layer, the third layer having a third thickness (T₃) and comprising an ultra-high molecular weight polyethylene (UHMWPE) composite or syntactic foam,
wherein a ratio of the second thickness to the third thickness (T₂/T₃) is between 0.42 and 1.0.

2. The panel of claim 1, wherein the material of the third layer comprises a material selected from the group consisting of random chopped fibers, aligned chopped fibers, unidirectional fibers, bidirectional fibers, cross-ply fibers, two-dimensional woven fibers, and three-dimensional woven fibers.

3. The panel of claim 2, wherein the material of the third layer is bonded together by a thermoplastic or thermoset polymer.

4. The panel of claim 1, wherein the second layer is configured to blunt, deform, erode, or fracture the projectile, when impacted by the projectile.

5. The panel of claim 1, wherein the third layer has a flexural modulus between 600-800 ksi as determined by ASTM D790.

6. The panel of claim 1, wherein the third layer has a flexural modulus between 675-725 ksi as determined by ASTM D790.

7. The panel of claim 1, further comprising a protective wrap covering side surfaces of each of the plurality of layers.

8. The panel of claim 1, wherein the panel is configured to be oriented with the first layer facing in a direction of potential projectiles when the panel is in use.

9. The panel of claim 1, wherein the first layer comprises a metal, a fiberglass reinforced polymer composite, or a carbon fiber reinforced polymer composite.

10. An armor panel comprising:
a first layer having a first thickness (T₁);
a second layer coupled to the first layer, the second layer having a second thickness (T₂) and being configured to configured to, when impacted by a projectile, blunt, deform, erode, or fracture the projectile; and
a third layer coupled to the second layer, the third layer having a third thickness (T₃) and being configured to provide structural support to the second layer by exhibiting, when impacted by the projectile, one or more of shear plugging or fiber breaking.

11. The panel claim 10, wherein the panel is configured to be oriented with the first layer facing in a direction of potential projectiles when the panel is in use.

12. The panel of claim 10, wherein the first layer comprises a metal, a fiberglass reinforced polymer composite, or a carbon fiber reinforced polymer composite.

13. The panel of claim 10, wherein the second layer comprises a material selected from the group consisting of steel, cermet, cemented carbide, and metal matrix composite.

14. The panel of claim 10, wherein the third layer comprises a fiber reinforced composite material.

15. The panel of claim 10, wherein the third layer comprises a material selected from the group consisting of random chopped fibers, aligned chopped fibers, unidirectional fibers, bidirectional fibers, cross-ply fibers, two-dimensional woven fibers, and three-dimensional woven fibers.

16. The panel of claim 14, wherein the material of the third layer is bonded together by a thermoplastic or thermoset polymer.

17. The panel of claim 10, wherein the third layer has a flexural modulus between 600-800 ksi as determined by ASTM D790, and wherein the third layer has a flexural modulus between 675-725 ksi as determined by ASTM D790.

18. An armor panel manufacturing method comprising:
cleaning surfaces of a core layer, the core layer comprising a material selected from the group consisting of steel, cermet, cemented carbide, and metal matrix composite;
preparing a surface of a front face layer by cleaning and abrading the surface;
applying an adhesive between the abraded surface of the front face layer and one of the surfaces of the core layer and placing the core layer in contact with the abraded surface of the front face layer;
preparing a surface of a back face layer, the back face layer comprising an ultra-high molecular weight polyethylene (UHMWPE) composite or a syntactic foam; and
applying an adhesive between the prepared surface of the back face layer and the core layer and placing the back face layer in contact with the core layer.

19. The method of claim 18, further comprising pressing the front face layer, the core layer, and the back face layer together with a pressure of between 0.5 and 50 lb/in².

20. The method of claim 18, wherein a ratio of a thickness of the core layer to a thickness of the back face layer is between 0.42 and 1.0.
